(19) United States
(12) Patent Application Publication
(10) Pub. No.: US 2024/0008482 A1
(43) Pub. Date: Jan. 11, 2024

(54) METHOD OF INACTIVATING A VIRUS USING A GLUTARALDEHYDE CONTAINING COMPOSITION

(71) Applicant: Antonietta MARTIN, Roodepoort (ZA)

(72) Inventor: Antonietta MARTIN, Roodepoort (ZA)

(21) Appl. No.: 18/546,919

(22) PCT Filed: Feb. 18, 2022
(86) PCT No.: PCT/ZA2022/050005

§ 371 Date: Aug. 17, 2023

(30) Foreign Application Priority Data
Feb. 18, 2021 (ZA) 2021/01103

(51) Int. Cl. A01N 35/02; A01N 25/06; A01N 25/30; A01P 1/00

(52) U.S. Cl. CPC A01N 35/02; A01N 25/06; A01N 25/30; A01P 1/00

(57) ABSTRACT

According to a first aspect of the invention, there is provided a method of inactivating a virus, by at least a 4-log₁₀ reduction respectively, comprising the step of applying to an environment containing the virus, a stable aqueous glutaraldehyde containing solution comprising: glutaraldehyde (OCH(CH₂)₃CHO); an alcohol ethoxylate non-ionic surfactant; a pH modifier, a buffer comprising at least sodium acetate trihydrate (NaC₂H₃O₂).

### FIELD OF THE INVENTION

This invention relates to a method of inactivating an enveloped and a non-enveloped virus using a glutaraldehyde containing composition.

### BACKGROUND TO THE INVENTION

The biocidal activity of aldehydes is based on the reactivity of the aldehyde group and its ability to undergo alkylation reactions. Formaldehyde and glutaraldehyde have been in use for sterilization and disinfection of medical devices for a long time. Formaldehyde is an excellent biocide, but high toxicity limits its use. Glutaraldehyde is widely used for routine disinfection of medical devices, like flexible fibre-optic endoscopes and heat-sensitive medical devices. Ortho-Phthalaldehyde (OPA) is a high-level disinfectant.

Glutaraldehyde, in particular, is well known as either a disinfecting or sterilising agent. This aldehyde has been shown to be a powerful external bactericidal, fungicidal and viricidal agent. It interacts with nitrogen moieties of membrane proteins and compromises cellular function by disrupting DNA and RNA. However, to be optimally effective, the pH of the glutaraldehyde solution must be at or above 8. It is difficult to maintain glutaraldehyde solutions at this pH as they are unstable.

In a 1997 study, glutaraldehyde was proven to have viricidal activity against the now hugely topical SARS-CoV family of viruses and, in particular, the SARS-CoV (Hanoi strain) and SARS-CoV (Isolate FFM-1). At 2.5% concentration and 0.5% concentration respectively, glutaraldehyde inactivated the respective viruses in 5 and 2 minutes. The European Centre for Disease Prevention and Control has reported, in an interim document released in February 2020, that 2% glutaraldehyde is effective against HCoV-229E. Thus, the viricidal activity of glutaraldehyde is proven in SARS-CoV strains, which are enveloped viruses, but its effect on SARS-CoV-2 is not so well understood.

Although glutaraldehyde is a known viricidal agent, with the advent of the current pandemic and the evolution of highly transmissible variants of SARS-CoV-2, it has become imperative that a viricidal agent does not only have to inactivate the virus, but to do so rapidly in clean and biofilm contaminated surfaces, so that the risk of viral particles in an environment does not infect other people within that environment.

It is an object of this invention at least to partially address the aforementioned problem.

### SUMMARY OF THE INVENTION

Hereinafter, “stable”, in the context of the invention, refers to an aqueous glutaraldehyde solution capable of being stored for a period of at least 12 months without the pH dropping below 5 or the molecules polymerising thereby causing the product to become viricidally ineffective.

Hereinafter, reference to “complex” refers to a process whereby the relevant reagents chemically interact or bond and “complexed” as a commensurate meaning.

Hereinafter, reference to “inactivation” refers to a loss of viral load with time due to disruption of coat proteins or degradation of nucleic acid, as quantified or verified by an appropriate method such as, for example, the Median Tissue Culture Infectious Dose (TCID₅₀) method, and “inactivate” has a commensurate meaning.

Hereinafter, reference to “viricidal” refers to the ability of a composition which accords with the invention to inactivate an enveloped or a non-enveloped virus by at least a 4-log₁₀ reduction.

Hereinafter, reference to concentration refers to an active concentration i.e. the concentration of viricidally active glutaraldehyde in a solution.

According to a first aspect of the invention, there is provided a method of inactivating a virus, by at least a 4-log₁₀ reduction respectively, comprising the step of applying to an environment containing the virus, a stable aqueous glutaraldehyde containing solution comprising:
(a) glutaraldehyde (OCH(CH₂)₃CHO);
(b) an alcohol ethoxylate non-ionic surfactant,
(c) a pH modifier;
(d) a buffer comprising at least sodium acetate trihydrate (NaC₂H₃O₂).

The environment may be an enclosed, or partially enclosed, volume (void) such as, for example, a room, a container or vehicle interior.

The solution may be applied to the volume by spraying into the volume an aerosolized form of the solution (a dispersant).

In applying the dispersant by spraying, the droplets of the dispersant may include glutaraldehyde in a concentration below 0.5%. Preferably, the droplets of the dispersant includes glutaraldehyde in a concentration of at least 0.2%, alternatively at least 0.4%.

The solution may include glutaraldehyde in a concentration ranging from 2% to 20% and, on application, the solution maybe diluted within the volume to bring the concentration of the glutaraldehyde, within the volume, to below 0.5%. Preferably, the concentration of the glutaraldehyde within the volume is at least 0.2%, alternatively at least 0.4%.

Alternatively, the environment may be a surface.

The solution may be applied, as a surface disinfectant, to the surface by direct application or by spraying.

The solution of the surface disinfectant may include glutaraldehyde in a concentration below 0.5%. Preferably, the solution includes glutaraldehyde in a concentration of at least 0.2%, alternatively 0.4%.

Alternatively, the solution may be a concentrate which includes glutaraldehyde in a concentration ranging from 2% to 20% and, prior to application, the solution maybe diluted with sterile or potable water to bring the concentration of the glutaraldehyde to below 0.5%.

Preferably, the solution is diluted to lower the concentration of the glutaraldehyde to at least 0.2%, alternatively 0.4%.

The enveloped virus may be inactivated by at least a 4-log₁₀ reduction within 2 minutes. Preferably the non-enveloped virus may be inactivated by at least a 4-log₁₀ reduction within 1 minute.

The non-enveloped virus may be inactivated by at least a 4-log₁₀ reduction within 17 minutes. Preferably, the non-enveloped virus may be inactivated by at least a 4-log₁₀ reduction within 16 minutes. More preferably, the non-enveloped virus may be inactivated by at least a 4-log₁₀ reduction within 15 minutes.

In a second aspect, the invention provides a viricidal composition which includes a stable aqueous glutaraldehyde containing solution including:
(a) glutaraldehyde (OCH(CH₂)₃CHO);
(b) an alcohol ethoxylate non-ionic surfactant,
(c) a pH modifier;
(d) a buffer comprising at least sodium acetate trihydrate (NaC₂H₃O₂);

The solution may include glutaraldehyde in a concentration below 0.5%. Preferably, the solution includes glutaraldehyde in a concentration of at least 0.2%, alternatively 0.4%.

Alternatively, the solution may be a concentrate which includes glutaraldehyde in a concentration ranging from 2% to 20% and, prior to use, the solution maybe diluted with sterile or potable water to bring the concentration of the glutaraldehyde to below 0.5%.

Preferably, the solution is diluted to lower the concentration of the glutaraldehyde is at least 0.2%, alternatively 0.4%.

In a third aspect, the invention provides use of a stable aqueous glutaraldehyde containing solution to inactivate a virus, by at least a 4-log₁₀ reduction, the solution including:
(a) glutaraldehyde (OCH(CH2)3CHO);
(b) an alcohol ethoxylate non-ionic surfactant,
(c) a pH modifier;
(d) a buffer comprising at least sodium acetate trihydrate (NaC2H3O2),

The solution may include glutaraldehyde in a concentration below 0.5%. Preferably, the solution includes glutaraldehyde in a concentration of at least 0.2%, alternatively 0.4%.

Alternatively, the solution may be a concentrate which includes glutaraldehyde in a concentration ranging from 2% to 20% and, prior to use, the solution maybe diluted with sterile or potable water to reduce the concentration of the glutaraldehyde to below 0.5%.

Preferably, the solution is diluted to reduce the concentration of the glutaraldehyde to at least 0.2%, alternatively 0.4%.

The stable aqueous glutaraldehyde containing solution, in use as a viricide to inactivate an enveloped and a non-enveloped viruses, wherein the concentration of the glutaraldehyde in the solution is dilute and below 0.5%, may be included in dispersible products such as, for example, spraying solutions, aerosol foggers, nasal sprays and nebulisers to aid in the treatment of respiratory infections (caused by enveloped viruses).

Alternatively, the stable aqueous glutaraldehyde containing solution, in use as the viricide, wherein the concentration of the glutaraldehyde in the solution is dilute and below 0.5%, may be included in contact-cleaning products such as, for example, food equipment cleaners, kitchen and bathroom surface cleaners, high-level disinfectant for medical devices, hand sanitizers, hand soaps and wipes.

The enveloped virus may be inactivated by at least a 4-log₁₀ reduction within 2 minutes. Preferably the non-enveloped virus may be inactivated by at least a 4-log₁₀ reduction within 1 minute.

The non-enveloped virus may be inactivated by at least a 4-log₁₀ reduction within 17 minutes. Preferably, the non-enveloped virus may be inactivated by at least a 4-log₁₀ reduction within 16 minutes. More preferably, the non-enveloped virus may be inactivated by at least a 4-log₁₀ reduction within 15 minutes.

In respect of each aspect of the invention, the virus may be an enveloped virus or a non-enveloped virus.

In respect of each aspect of the invention, the enveloped virus may be a member of Filovirdae, Flaviviridae, Herpesviridae, Coronviridae, Orthomyxoviridae, Paramyxoviridae or Poxviidae.

More particularly, the enveloped virus may be anyone of the following: Hepatitis B Virus (HBV), Hepatitis Delta Virus (HDV), Human Immunodeficiency Virus (HIV), Human T Cell Leukaemia Virus (HTLV), Rabies Virus, Rubella Virus, HSV-1, HSV-2, varicella-zoster virus, Hepatitis C Virus (HCV), measles virus, smallpox virus, human influenza viruses, MERS-CoV, SARS-CoV-1 and SARS-CoV-2 and Ebola virus.

In respect of each aspect of the invention, the non-enveloped virus may be a member of Adenoviridae or Picornaviridae.

More specifically, the non-enveloped virus may be poliovirus type 1, Murine Norovirus (MNV) and adenovirus type 5.

In respect of each aspect of the invention, preferably, the alcohol ethoxylate non-ionic surfactant has between 3 and 9 ethoxylate groups.

In respect of each aspect of the invention, the pH modifier may be a base, such as a dilute aqueous solution of sodium hydroxide, potassium hydroxide or sodium bicarbonate.

In respect of each aspect of the invention, the pH modifier is added in a sufficient quantity to bring the pH of the solution to within a range 7 to 9.

### BRIEF DESCRIPTION OF THE FIGURES

The invention is described by way of examples with reference to the accompanying Figures in which:

FIG. 1 is a graph displaying results of a test to determine the viricidal efficacy of a stable aqueous glutaraldehyde containing solution in accordance with the invention against modified vaccinia virus Ankara (MVA);

FIG. 2 is a graph displaying results of a test to determine the viricidal efficacy of a formaldehyde solution against MVA;

FIG. 3 is a graph displaying results of a test to determine the viricidal efficacy of the stable aqueous glutaraldehyde containing solution against poliovirus type 1;

FIG. 4 is a graph displaying results of a test to determine the viricidal efficacy of a formaldehyde solution against poliovirus type 1;

FIG. 5 is a graph displaying results of a test to determine the viricidal efficacy of the stable aqueous glutaraldehyde containing solution against MNV;

FIG. 6 is a graph displaying results of a test to determine the viricidal efficacy of a formaldehyde solution against MNV;

FIG. 7 is a graph displaying results of a test to determine the viricidal efficacy of the stable aqueous glutaraldehyde containing solution against adenovirus type 5; and

FIG. 8 is a graph displaying results of a test to determine the viricidal efficacy of a formaldehyde solution against adenovirus type 5.

### DESCRIPTION OF EMBODIMENTS OF THE INVENTION

The applicant has developed a stable aqueous glutaraldehyde containing solution for treating, deactivating and/or destroying enveloped and non-enveloped viruses.

The solution includes a non-toxic surfactant, namely an alcohol ethoxylate non-ionic surfactant. The solution also includes sodium acetate trihydrate and a sufficient amount of a pH modifier to bring the initial pH of the solution, on manufacture of the solution, to within a range of 7.0 to 9.0.

The glutaraldehyde containing solution of the invention is conveniently formulated as a concentrate comprising 2% to 20% glutaraldehyde and as much sodium acetate trihydrate as is required to buffer the pH of the solution to maintain the pH of the solution within its stable shelf-life to not fall below 5.0. Typically the concentration of sodium acetate trihydrate required is from 0.05 to 1.5% m/v.

### Methodology for Preparation of the Solution

In preparing the concentrate, the alcohol ethoxylate surfactant, for example Tergitol® 15.S9, is added to a predetermined volume of water. The mixture is then heated to a temperature between 40° C. and 50° C. Then the glutaraldehyde is added within this temperature range for a period of between 30 and 60 minutes. This time is considered sufficient to allow the glutaraldehyde to complex with the alcohol ethoxylate. The result is a glutaraldehyde-surfactant complexed solution.

The alcohol ethoxylate non-ionic surfactant typically makes up 0.3 to 20% of the solution.

Thereafter, additional water at room temperature is added to the glutaraldehyde-surfactant complexed solution to bring the temperature of the solution to below 30′C. This temperature drop has the effect of stopping the complexing reaction of the alcohol ethoxylate with the aldehyde.

A pH modifier, such as a 1 molar sodium or potassium hydroxide solution, is then added in a sufficient quantity to raise the pH of the glutaraldehyde-surfactant complexed solution to between 7.0 and 9.0.

At this pH, the glutaraldehyde-surfactant complexed solution is buffered with sodium acetate trihydrate, functions as a buffer to maintain the pH of the solution within its stable shelf-life to not fall below 5.0 to produce the concentrate of the stable aqueous glutaraldehyde containing solution.

The applicant suggests that the surfactant may be chemically bind to the glutaraldehyde, forming a complex, in which the glutaraldehyde molecules are held in a more viricidally effective linear configuration.

Furthermore, the surfactant component of the solution is thought to have an additional adjunctive effect of breaking down biofilms and oily surfaces, enabling the solution to penetrate the biofilm or oily barrier, taking with it the chemically bonded viricidal component being glutaraldehyde. In effect, the solution has a “built-in” wetting agent.

The applicant believes that the surfactant in the stable aqueous glutaraldehyde containing solution constitutes a first line of attack on enveloped and non-enveloped viruses, analogous to cell lysis and protein extraction in which a surfactant or detergent monomer solubilises membrane proteins by partitioning into the membrane bilayer. This disrupts membrane lipid/protein interactions, which are effectively exchanged for surfactant/protein interactions.

In enveloped and non-enveloped viruses, the nucleocapsid is surrounded by a lipid bilayer that closely surrounds a shell of virus-encoded membrane-associated proteins. The applicant believes that the surfactant in the solution solubilises the virus lipid bilayer, thereby exposing the viral protein of its nucleus to glutaraldehyde fixation destruction. The glutaraldehyde and surfactant, being therefore complexed, have a stronger sanitising effect, cleaning and disinfecting at the same time.

In the below examples, the concentrate of the invention comprises 10% m/v glutaraldehyde. However, the concentrate can comprise other concentrations of glutaraldehyde depending on the application of the concentrate.

### Viricidal Test Protocol

To prove the viricidal efficacy of the stable aqueous glutaraldehyde containing solution according to the invention, a number of tests were performed against viral candidates against the stringent European viricidal testing standard, Standard EN14476 version A2 of 2019 (“the Standard”). Driven by the SARS-CoV-2 pandemic, this standard has introduced the inclusion of non-enveloped viruses which generally are more resistant to changes in temperature, pH, and disinfectants.

The candidate virus have been chosen as representative of a broad range of virus, based in the assumption that if the tested disinfectant formulation displays viricidal properties against these “harder to kill” viruses, the formulation will display viricidal properties against other viruses in the particular enveloped/non-enveloped categories.

The candidate non-enveloped viruses were adenovirus type 5, Nora virus (MNV) and the poliovirus type 1. The sole candidate for an enveloped virus was modified vaccinia virus Ankara (MVA).

The results of the tests are benchmarked against a 0.7% active formaldehyde solution, a well-used high-level disinfectant.

Following the Standard, the virus-inactivating properties of the stable aqueous glutaraldehyde containing solution were tested against each viral candidate using a quantitative suspension protocol according to the Standard, under clean conditions. The outcome of each test is set out below.

According to the Standard, a solution at a particular concentration is considered as having virus-inactivating properties (viricidal activity) if within the recommended exposure period the viral titre is reduced by ≥4 log 10 i.e. 299.99% of the virus are inactivated.

A starting solution, for these tests, is a 10% m/v concentrate of a stable aqueous glutaraldehyde containing solution (hereinafter referred to as G-cide 10%). The ingredients of this concentrate solution is:
200 Kg to 226 Kg Ucarcide® 250 which includes 50% w/w glutaraldehyde;
6 Kg to 22 Kg Tergitol® 15.S9;
2.5 Kg to 10 Kg sodium acetate trihydrate; and
sodium hydroxide in a sufficient quantity to bring the pH of the solution to 7.5.

The ingredients were combined using the methodology described above.

For preparation of the test virus suspension, BHK 21-cells were cultivated for preparation of test virus suspension. Cells were infected with the particular viral candidate. After the cells showed a cytopathic effect, they were subjected to a freeze/thaw procedure followed by a low speed centrifugation in order to sediment cell debris. After aliquotation, the test virus suspension was stored at −80° c.

For preparation of the disinfectant, two concentrations of the G-cide 10% were prepared and subjected to the tests i.e. a 4.0% and 2.0% solution under clean conditions (0.4% and 0.2% active concentrations respectively).

The test virus suspension and the disinfectant were prepared immediately before each inactivation test.

Infectivity was determined as an endpoint titration according to EN 5.5. Calculation of the infective dose TCID₅₀/ml was calculated with the method of Spearman and Karber.

The viricidal activity of the test disinfectant was evaluated by calculating the decrease in titre in comparison with the control titration without disinfectant. The difference is given as a reduction factor (RF). As mentioned, according to the Standard, a disinfectant or a disinfectant solution at a particular concentration is considered to have virus-inactivating efficacy if the titre is reduced at least by 4 log₁₀ steps within the recommended exposure period.

In order to eliminate the possible cytotoxicity effect of the test product, a large volume plating method (EN 5.5.4.3) was used.

For the control of cell sensitivity to the viral candidate, two parts by volume of water were mixed with eight parts by volume of the lowest apparently non-cytotoxic dilution of the test product. These mixtures, and a PBS control, were added to a volume of double concentrated cell suspension. After 1 hour at 37° C. the cells were centrifuged and re-suspended in cell culture medium (EN 5.5.4.2b). Finally, a comparative titration of the test virus suspension was performed on the pre-treated (disinfectant) and non-pre-treated (PBS) cells.

The tests were carried out at 20° C., with 1 minute, 3 minute and 15 minute exposure times.

### Example 1—Modified Vaccinia Virus Ankara (MVA)

The virus-inactivating properties of the glutaraldehyde solution against modified vaccinia virus Ankara (MVA) were investigated by applying the protocol above.

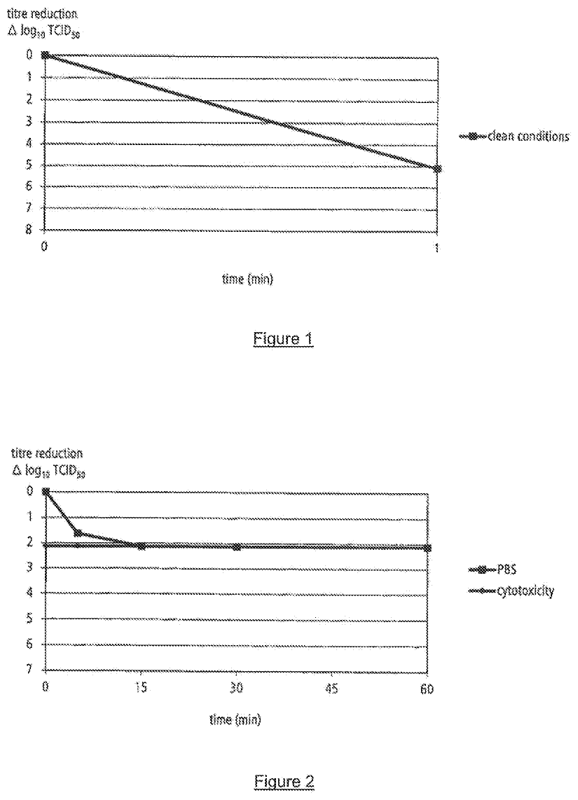

The results of the test are graphically illustrated in FIG. 1.

The tests showed that in order to achieve a 4 log₁₀ reduction under dean conditions according to the Standard, the concentration of 2.0% of a 10% concentrate and an exposure time of 1 minute is required. With this evaluation, the glutaraldehyde solution can be declared as having viricidal activity (virus inactivating properties) against all enveloped viruses at an effective level of 0.2% active.

These results compare extremely favourably when compared to the virus-inactivating properties of formaldehyde (see FIG. 2).

### Example 2—Poliovirus

The virus-inactivating properties of the stable aqueous glutaraldehyde containing solution (solution) against poliovirus type 1 were investigated by applying the protocol above.

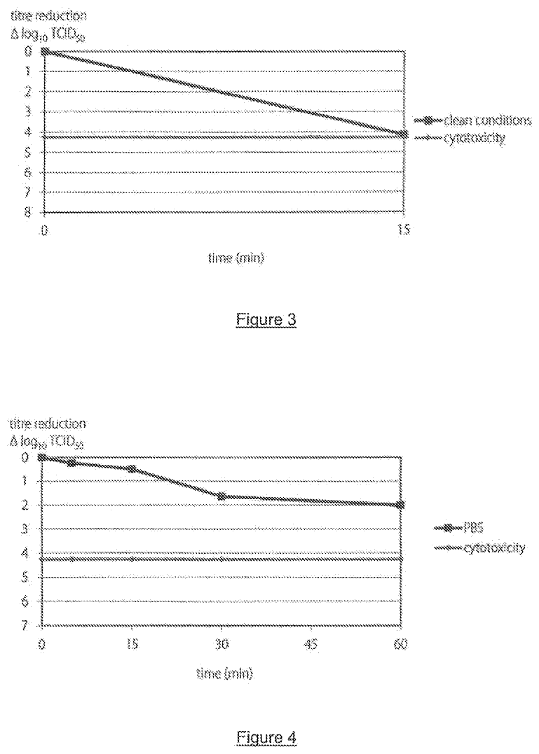

The results of the test are graphically illustrated in FIG. 3.

The tests showed that in order to achieve a 4 log₁₀ reduction under clean conditions according to the Standard, the concentration of 4.0% of a 10% concentrate and an exposure time of 15 minutes is required. With this evaluation, the solution can be declared as having viricidal activity (virus inactivating properties) against this type of non-enveloped virus at an effective level of 0.4% active.

These results compare extremely favourably when compared to the virus-inactivating properties of formaldehyde (see FIG. 4) which never achieves a 4 log₁₀ reduction.

### Example 3—MNV

The virus-Inactivating properties of the solution against MNV were investigated by applying the protocol above.

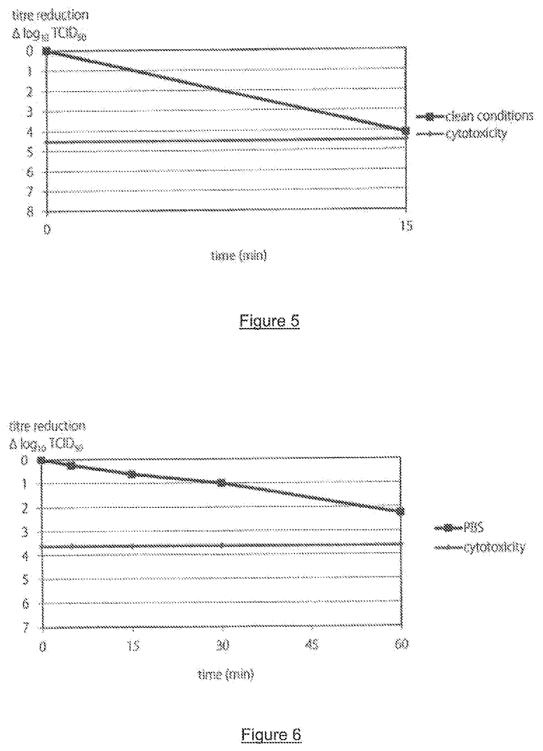

The results of the test are graphically illustrated in FIG. 5.

The tests showed that in order to achieve a 4 log₁₀ reduction under clean conditions according to the Standard, the concentration of 4.0% of a 10% concentrate and an exposure time of +/−15 minutes is required. With this evaluation, the solution can be declared as having viricidal activity (virus inactivating properties) against this type of non-enveloped virus at an effective level of 0.4% active.

These results compare extremely favourably when compared to the virus-inactivating properties of formaldehyde (see FIG. 6) which once again never achieves a 4 log₁₀ reduction.

### Example 4—Adenovirus

Finally, the virus-inactivating properties of the glutaraldehyde solution against adenovirus type 5 were investigated by applying the protocol above.

The results of the test are graphically illustrated in FIG. 7.

The tests showed that in order to achieve a 4 log₁₀ reduction under clean conditions according to the Standard, the concentration of 2.0% of a 10% concentrate and an exposure time of 15 minutes is required. With this evaluation, the glutaraldehyde solution can be declared as having viricidal activity (virus inactivating properties) against this type of non-enveloped virus at an effective level of 0.2% active.

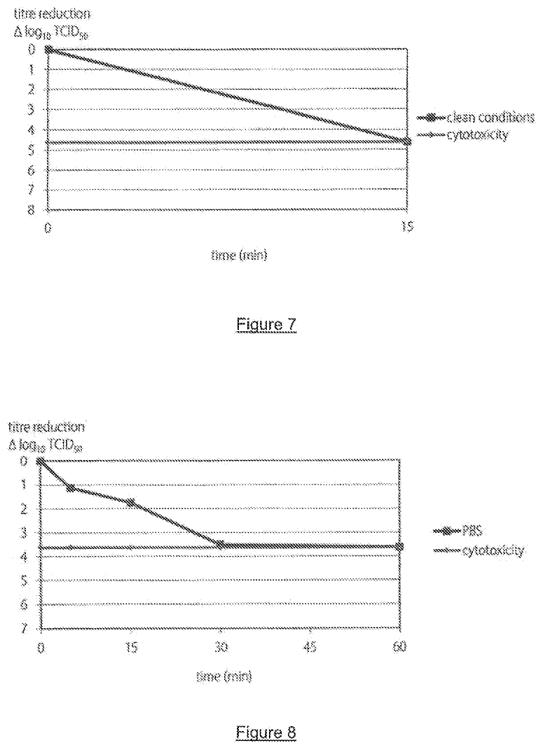

These results compare extremely favourably when compared to the virus-inactivating properties of formaldehyde (see FIG. 8) which achieves a 4 log₁₀ reduction but only after 30 minutes at a higher relative concentration.

### SUMMARY

Due to the evident highly viricidally efficacy of the stable aqueous glutaraldehyde containing solution, the solution can be used in a range of commercial, medical or domestic products, for a variety of methods of application, such as surface cleaning, spraying, fogging and fumigating, to inactivate enveloped or non-enveloped viruses.

1. A method of inactivating a virus by at least a 4-log 10₁₀ reduction comprising the step of applying, to an environment containing the virus, a stable aqueous glutaraldehyde containing solution comprising:
(e) glutaraldehyde;
(f) an alcohol ethoxylate non-ionic surfactant,
(g) a pH modifier; and
(h) a buffer comprising at least sodium acetate trihydrate.

2. The method according to claim 1, wherein the environment is an enclosed, or partially enclosed, volume.

3. The method according to claim 1, wherein the solution is applied to the volume by spraying into the volume an aerosolized form of the solution.

4. The method according to claim 3, wherein droplets of the aerosolized form of the solution include glutaraldehyde in a concentration below 0.5%.

5. The method according to claim 4, wherein droplets of the aerosolized form of the solution include glutaraldehyde in a concentration of at least 0.2%.

6. The method according to claim 4, wherein droplets of the aerosolized form of the solution include glutaraldehyde in a concentration of at least 0.4%.

7. The method according to claim 1, wherein the environment is a surface.

8. The method according to claim 7, wherein the solution is applied to the surface by direct application or by spraying.

9. The method according to claim 8, wherein the solution includes glutaraldehyde in a concentration below 0.5%.

10. The method according to claim 9, wherein the solution includes glutaraldehyde in a concentration of at least 0.2%.

11. The method according to claim 9, wherein the solution includes glutaraldehyde in a concentration of at least 0.4%.

12. The method according to claim 8, wherein the solution includes glutaraldehyde in a concentration ranging from 2% to 20% and, prior to application, the solution is diluted with water to bring the concentration of glutaraldehyde to below 0.5%.

13. The method according to claim 12, wherein the solution is diluted with water to being the concentration of glutaraldehyde to at least 0.2%.

14. The method according to claim 12, wherein the solution is diluted with water to being the concentration of glutaraldehyde to at least 0.4%.

15. The method according to claim 1, wherein the virus is an enveloped virus.

16. The method according to claim 15, wherein the enveloped virus may be inactivated by at least a 4-log₁₀ reduction within 2 minutes.

17. The method according to claim 15, wherein the enveloped virus may be inactivated by at least a 4-log₁₀ reduction within 1 minute.

18. The method according to claim 1, wherein the virus is a non-enveloped virus.

19. The method according to claim 18, wherein the non-enveloped virus is inactivated by at least a 4-log₁₀ reduction within 17 minutes.

20. The method according to claim 18, wherein the non-enveloped virus is inactivated by at least a 4-log₁₀ reduction within 16 minutes.

21. The method according to claim 18, wherein the non-enveloped virus is inactivated by at least a 4-log₁₀ reduction within 15 minutes.
